(19) United States
(12) Patent Application Publication
(10) Pub. No.: US 2014/0224448 A1
(43) Pub. Date: Aug. 14, 2014

(54) HVAC Airbox Systems and Methods

(71) Applicant: Sudhindra Uppuluri, St. Paul, MN (US)

(72) Inventor: Sudhindra Uppuluri, St. Paul, MN (US)

(73) Assignee: Computational Sciences Experts Group, LLC, Minneapolis, MN (US)

(21) Appl. No.: 13/767,562

(22) Filed: Feb. 14, 2013

(51) Int. Cl. B60H 1/00

(52) U.S. Cl. CPC B60H 1/00021
USPC 165/42

(57) ABSTRACT

A dual use of a heater core that enables heating the cabin, cooling the engine or both on demand regardless of the passenger's cabin heating and cooling requirements. This use of the heater core is enabled by an HVAC airbox system with a cooling door that can be selectively positioned such that at least some of the air moving through the heater core is directed to the underhood area of a vehicle thereby providing supplemental engine cooling on demand regardless of the passenger's cabin heating and cooling requirements. The cooling door can be positioned automatically by the Engine Control Unit (“ECU”) dependent on any parameter, or combination of parameters, of the engine such as the engine coolant temperature or the engine oil temperature. The blower speed and the position of the cooling door are adjusted by the ECU depending on the whether and how much supplemental engine cooling is required.

### BACKGROUND

1. Field of the Invention

The present invention relates generally to heating, ventilation and air conditioning (“HVAC”) airbox systems and methods of cooling an engine. Particularly, the present invention relates to HVAC airbox systems and cooling methods for an engine, which is part of a vehicle having a passenger cabin and an underhood area in which the HVAC airbox system is located. Even more particularly, preferred HVAC airbox systems have a dual use of a heater core that enables heating the passenger cabin, cooling the engine or both on demand regardless of the passenger's cabin heating and cooling requirements.

2. Description of the Related Art

Combustion engines must be cooled to prevent overheating, which can cause damage to the engine. In a typical engine cooling system, a radiator is primarily used for cooling the engine, whereas a heater core draws heat from the engine and is used to heat the cabin. When the cabin is being heated, the heater core draws heat from the engine and contributes to engine cooling. However, when the cabin heat is not turned on, there is no airflow across the heater core and, therefore, the heater core does not draw heat from the engine.

The present invention addresses problems and limitations associated with the related art.

### SUMMARY OF THE INVENTION

The present invention uses a heater core of a vehicle in not only heating the passenger cabin but also for engine cooling. In preferred heating, ventilation and air conditioning (“HVAC”) airbox systems, the airbox is configured to enable airflow across the heater core by implementing a cooling door such that at least some of the air from exiting the heater core is directed to the underhood area of the vehicle. This contributes to engine cooling on demand, even when passenger cabin heating is turned off. Such a configuration enables the heater core to supplement the radiator in engine cooling, which means that the radiator can be smaller and/or require less airflow through the front grill, which can directly improve the fuel economy of the vehicle.

Preferred HVAC airbox systems are configured for a combustion engine, which is part of a vehicle having a radiator having a coolant capable of absorbing heat from the engine, a passenger cabin and an underhood area in which the HVAC airbox system is located. The HVAC airbox system includes a heater core connected to the engine using coolant passages such that heat absorbed by the coolant can be transferred to the heater core. The HVAC airbox system further includes at least one blower capable of directing air through the heater core and a cooling door that can selectively be positioned such that at least some of the air moving through the heater core is directed to the underhood area of the vehicle.

The invention also includes methods of cooling an engine. Preferred methods of the invention generally include at least partially opening or closing the cooling door such that at least some of the air from exiting the heater core is directed to the underhood area of the vehicle. Whether the cooling door is opened or closed can depend on a variety of factors including coolant temperature or whether the passenger cabin heat is on, for example. In preferred methods, the HVAC airbox system is configured to have high and low threshold temperatures for the engine coolant. Preferably, the cooling door opens such that air is directed to the underhood area when the coolant temperature reaches the high threshold temperature and the cooling door closes when the coolant temperature reaches the low threshold temperature such that air is no longer directed to the underhood area. During such operation, the heater core provides supplemental cooling of the engine.

These and various other advantages and features of novelty which characterize the present invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described preferred embodiments of the present invention.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include corresponding parts;

FIG. 1 is a partial, perspective view of a vehicle V having a hood H, a radiator 112, an engine 124 and a HVAC airbox system 110 having an AC evaporator 120, a heater core 140 and a blower (blower 116 not shown in this Figure for clarity);

FIG. 2 is a schematic illustration of a known HVAC airbox system 10;

FIG. 3 is a schematic illustration of a preferred HVAC airbox 110 of FIG. 1, the HVAC airbox 110 including heater core 140 and a cooling door 134; wherein the cooling door 134 is positioned to direct air A4 exiting the heater core 140 to an underhood area U of the vehicle V;

FIG. 4 is a schematic illustration of the preferred HVAC airbox system 110 of FIGS. 1 and 3, wherein the cooling door 134 is positioned to direct air A4 exiting the heater core 140 into the passenger cabin C of the vehicle V;

FIG. 5 is a schematic illustration of the preferred HVAC airbox system 110 of FIGS. 1 and 3-4, wherein the cooling door 134 is positioned to direct air exiting the heater core 140 into both the underhood area U and the passenger cabin C of the vehicle V;

FIG. 6 is a schematic illustration of the preferred HVAC airbox system 110 of FIGS. 1 and 3-5, wherein an air conditioning evaporator 120 of the HVAC airbox system 110 is on and is directing cool, dehumidified air into the passenger cabin C, bypassing the heater core 140 to cool the passenger cabin C;

FIG. 7 is a schematic illustration of a second preferred HVAC airbox system 110′ including first and second blowers 116′, 116″, one blower 116′ for directing air to through the AC evaporator 120 to the passenger cabin C and the second blower 116″ dedicated to directing air to a heater core 140″;

FIG. 8 is a schematic illustration of an alternative known HVAC airbox system 10′;

FIG. 9 is a schematic illustration of a preferred HVAC airbox system 210 including a cooling door 234 that can direct air from a heater core 240 to the underhood area U of the vehicle V, wherein air A4 directed to the underhood U is further transferred down a duct 260 to the bottom of the vehicle V;

FIG. 10 is a flow chart illustrating one preferred method of operating the HVAC airbox systems 110, 110′, 210;

FIG. 11A is a first part of a flow chart illustrating another preferred method of operating the HVAC airbox systems of 110, 110′, 210; and

FIG. 11B is a second part of the flow chart of FIG. 11A illustrating one preferred method of operating the HVAC airbox systems 110, 110′, 210.

### DETAILED DESCRIPTION OF THE PREFERRED EMBODIMENTS

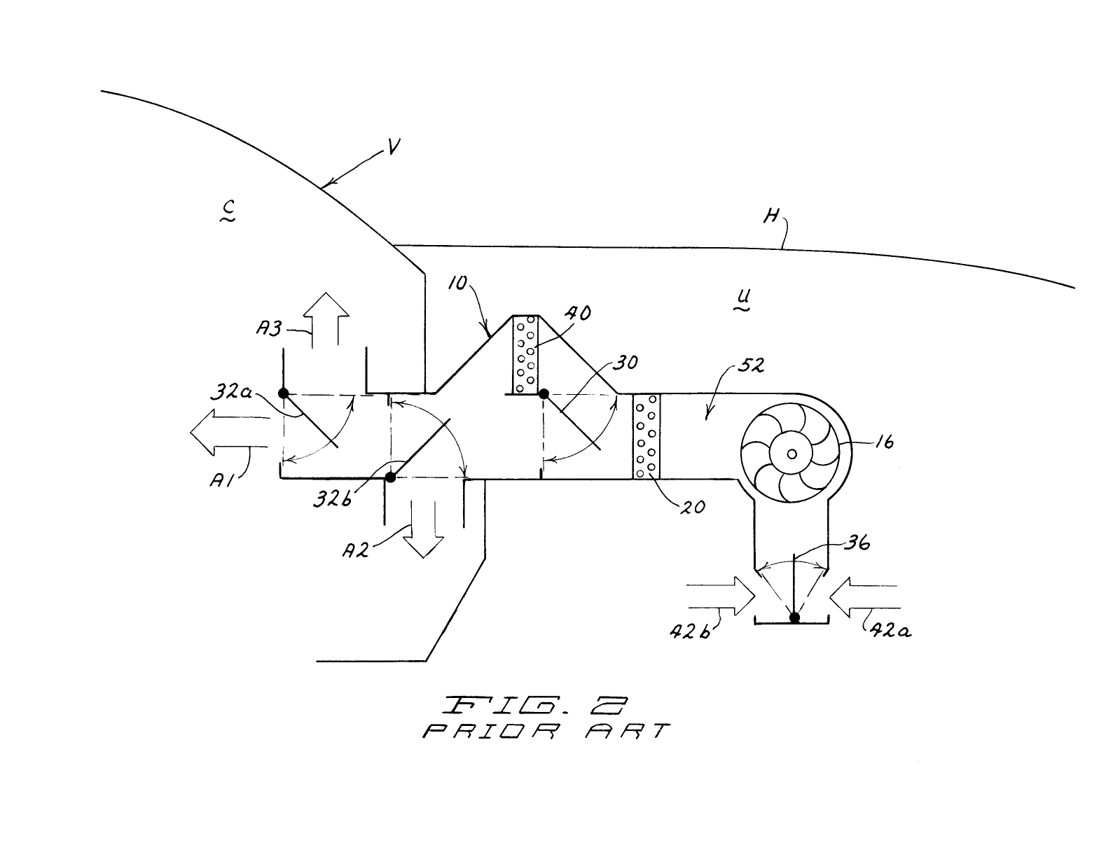

Known HVAC airbox systems 10, 10′ are illustrated in FIGS. 2 and 8. In these systems, air is directed through an airbox or passageway 52, 52′ to an AC evaporator 20, 20′ with a blower 16, 16′. A blend door 30, 30′ can then selectively direct the air from the AC evaporator 20, 20′ to either the passenger cabin (via cabin vent doors 32a, 32b, 32a′, 32b′) or to the heater core 40, 40′ or both areas. If air is directed to the heater core 40, 40′, the air passing through the heater core will be heated and can only escape the system via passenger cabin vent doors 32a, 32b, 32a′, 32b′ (see air A1-A3). If heated airflow is not desired in the passenger cabin C, there is no airflow across the heater core 40, 40′, and therefore it cannot remove heat from the engine. The HVAC airflow system preferably further includes a blower door 36, 36′ which can selectively direct fresh air 42a or re-circulated air 42b into the system and toward blower 16, 16′.

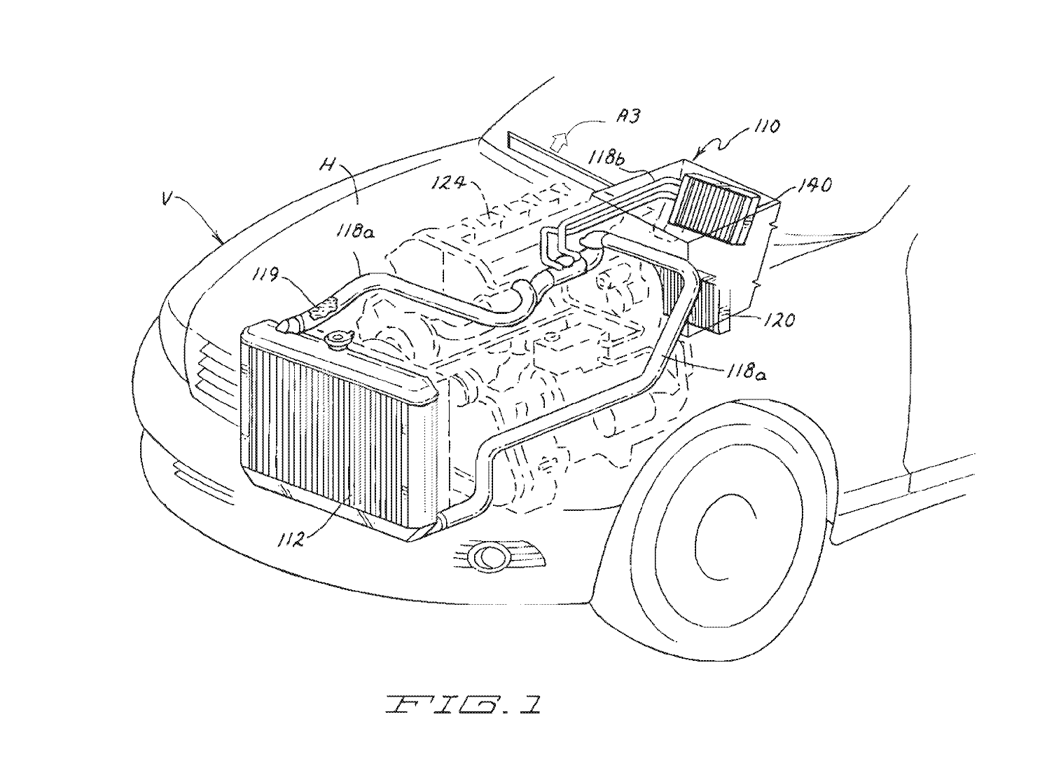

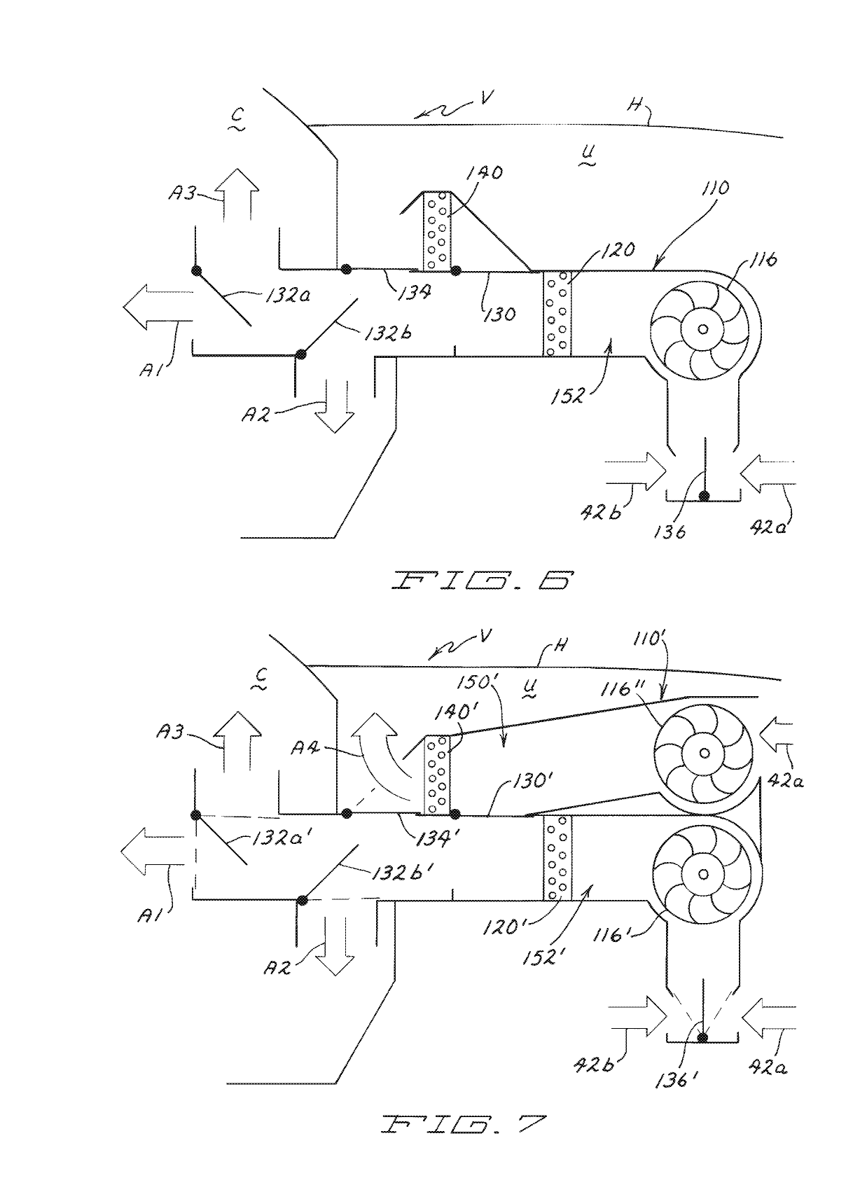

HVAC airbox systems 110, 110′, 210 of the present invention, such as the ones disclosed herein, can be used for cooling an engine 124, located in the underhood area U, under the hood H of a vehicle V, which has a passenger cabin C that may be heated or cooled, as desired. Illustrative embodiments are shown in FIGS. 1 and 3-7 and 9-11B. Collectively, FIGS. 1 and 3-6 illustrate one preferred HVAC airbox 110, a radiator 112 having hoses 118a filled with coolant fluid 119 and a fan (not shown) that can direct air across the radiator 112 and a blower 116 to direct air toward an AC evaporator 120 and heater core 140. As with known systems, the engine 124 is fluidly connected with hoses 118b to the heater core 140. Hoses 118a are interconnected to hoses 118b. Air A1-A3 can be directed, via a blend door 130, to a passenger cabin of the vehicle via cabin vent doors 132a, 132b, to the heater core 140 or to both the heater core 140 and the passenger cabin C. A passageway 152 for air movement is located between the blower door 136, blower 116, AC evaporator 120, heater core 140 cabin vent doors 132a, 132b and passenger cabin C. Blower door 136 is configured to selectively allow blower 116 to intake either fresh air 42a from the outside of the vehicle V or re-circulated air 42b from inside the passenger cabin C. The HVAC airflow system 110 further includes a cooling door 134 which can be selectively positioned to direct air via a first passageway 150 either to the underhood area U of the vehicle V or to the passenger cabin C or both. The cooling door 134 preferably is pivotal and has at least three positions, wherein, in the first position, air A4 exiting the heater core 140 is directed to the passenger cabin C; in the second position, air A4 exiting the heater core 140 is directed to the underhood area U; and, in the third position, air A4 exiting the heater core 140 is directed to both the passenger cabin C and the underhood area U. Preferably, the cooling door 134 will have many positions in between fully open and fully closed to enable a precise control of air temperature entering the passenger cabin C. Therefore, preferred embodiments are capable of supplementing the cooling of the engine 124 by using the heater core 140 on demand at all operating conditions regardless of whether the cabin heating is turned on or off. A blower 16 for the heater core 140 is provided to direct airflow across the heater core 140, and this heated air A4 is vented to the underhood area U if the passenger does not desire cabin C heating. Such a configuration enables the heater core 140 to have airflow across it on demand and draw heat from the engine 124 even when the passenger cabin C heating is turned off. In preferred embodiments, the cooling door 134 is activated automatically by an engine control unit (“ECU” or powertrain control module “PCM”) depending on any parameter in the engine such as coolant fluid 119 temperature or engine oil temperature, for example. The invention is not intended to be limited to any specific metric for evaluating engine temperature. It will be understood that different car OEMs might want to set different trigger or threshold points to activate the cooling door depending on what other fuel economy strategies may be employed by the particular vehicle design.

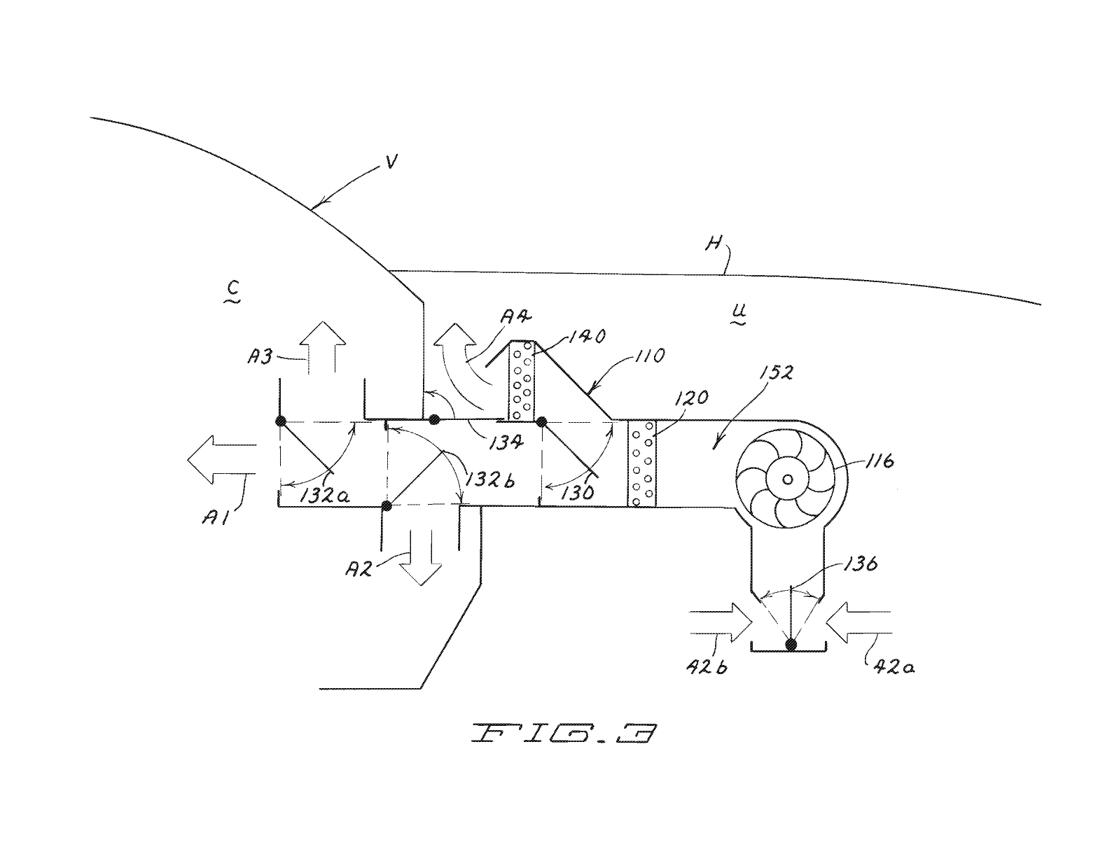

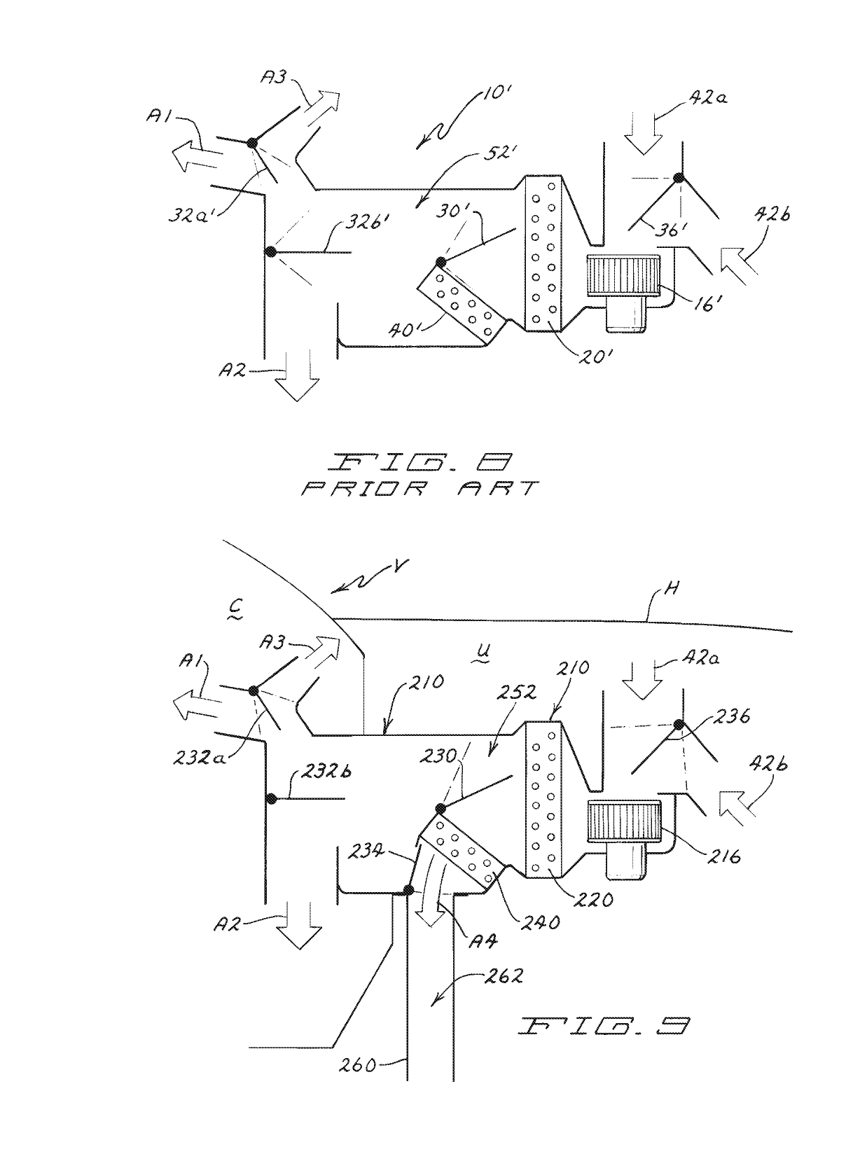

Referring now also to FIG. 7, which illustrates another preferred HVAC airbox 110′. In this embodiment, two blowers 116′, 116″ are employed. HVAC airbox system 110′ can be used with a vehicle V having an engine 124 capable of producing heat, a radiator 112 and fan capable of directing air past the radiator 112 (see engine 124 and radiator 112 disclosed herein). HVAC airbox system 110′ includes a heater core 40′ fluidly connected to the engine 124 other and at least one of the two blowers 116′ 116″ (see also, FIG. 1 and the discussion thereof). One blower 116″ directs air to the heater core 140′ via a first passageway 150′ and the second blower 116′ directs air to the AC evaporator 120′ via a second passageway 152′. Blower door 136′ is configured to selectively allow blowers 116′, 116″ to intake either fresh air 42a from outside of the vehicle V or re-circulated air 42b from inside the passenger cabin C. Cabin vent doors 132a′, 132b′ are employed to direct air A4 into the passenger cabin C and cooling door 134′ is configured to direct air toward the passenger cabin C, the underhood area U of the vehicle V or both areas as also disclosed with respect to FIGS. 1 and 3-6. As before, the cooling door 134′ preferably is pivotal and has at least three positions, wherein, in the first position, air A4 exiting the heater core 140′ is directed to the passenger cabin C; in the second position, air A4 exiting the heater core 140′ is directed to the underhood area U; and, in the third position, air A4 exiting the heater core 140′ is directed to both the passenger cabin C and the underhood area U. Preferably, the cooling door 134′ will have many positions in between fully open and fully closed to enable a more precise control of air temperature entering the passenger cabin C. Such an embodiment may be preferred over the single blower embodiment if a single blower cannot sufficiently deliver enough air to the AC evaporator 120′ for cooling the passenger cabin C and enough air to the heater core 140′ for cooling the engine 124 at the same time. Advantages of the HVAC airbox system 110′ of FIG. 7 potentially include less noise, more control of airflow and more airflow at a higher efficiency as compared to a single blower system such as that illustrated in FIGS. 3-6. Disadvantages of the HVAC airbox system 110′ of FIG. 7 as compared to the HVAC airbox system 110 of FIGS. 3-6 include additional cost, additional space required for the second blower and more power is consumed by two blowers, which may offset some of the fuel economy gains.

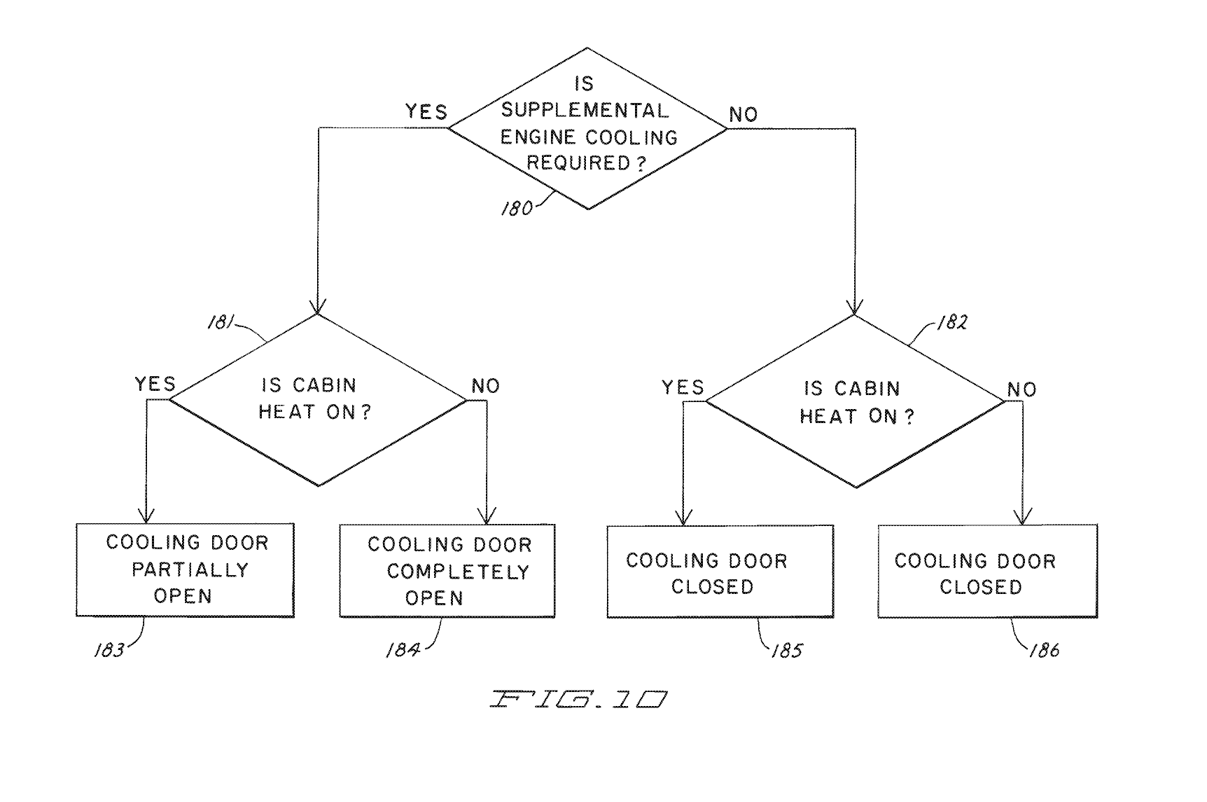

Yet another alternate HVAC airbox system 210 is illustrated in FIG. 9. In previously disclosed embodiments, there are no aspects of the HVAC airbox system that assist to dissipate the heated air once it is vented to the underhood area U. Air in the underhood area U will eventually escape the system through the bottom of the vehicle V. In alternative embodiments as illustrated in FIG. 9, the HVAC airbox system 210 can include a duct 260 proximate an exit area 262 near the heater core 240 such that hot air A4 exiting the heater core 240 is directed through the duct 260 and to the bottom of the vehicle V, or alternate location, as desired. Such embodiments will help reduce the temperature of the underhood area U, which could lower the temperature of the engine 124. Such embodiments are also beneficial in that they are believed to increase the airflow through the front-end radiator (see, for example, radiator 112 of FIG. 1) by lowering the airflow resistance. Whether this increase in airflow and other benefits of releasing the heated air to the bottom of the vehicle is worth the additional costs is up to the preference of the vehicle manufacturer.

The HVAC airbox system 210 of FIG. 9 includes a blower 216 that directs air past an AC evaporator 220. From there, a blend door 230 directs the air either through a heater core 240 if heating of the passenger cabin C is desired or directly to the passenger cabin C if no heating is desired. Passenger cabin vent doors 232a, 232b can selectively direct air A1-A3 to various areas of the passenger cabin C, as with previous embodiments. An airbox or passageway 252 for air movement is located between the blower door 236, blower 216, AC evaporator 220, heater core 240 cabin vent doors 232a, 232b and passenger cabin C. Blower door 236 is configured to selectively allow blower 216 to intake either fresh air 42a from outside of the vehicle V or re-circulated air 42a from inside the passenger cabin C. This invention differs from the prior art embodiment illustrated in FIG. 8 in that a cooling door 234 can direct the airflow from the heater core to the underhood when the cabin heating is not required but the supplemental engine cooling is required. This air flow through the heater core 240 can then, if required, be directed via duct 260 toward the bottom of the vehicle V when blend door 230 and cooling door 234 are selectively positioned as illustrated in FIG. 9. It will be understood that duct 260 is not required. The cooling door 234 preferably is pivotal and has at least three positions, wherein, in the first position, air A4 exiting the heater core 240 is directed to the passenger cabin C; in the second position, air A4 exiting the heater core 240 is directed to the underhood area U; and, in the third position, air A4 exiting the heater core 240 is directed to both the passenger cabin C and the underhood area U.

The cooling doors and blend/vent doors 130, 132a, 132b, 134, 132a′, 132b′, 134′, 230, 232a, 232b, 234 of the present invention may be of the type used for other vent doors used in known vehicle HVAC airflow systems. For example, the cooling and cabin blend/vent doors 30, 32a, 32b, 34, 32a′, 32b′, 34′ can be of the type commonly used to regulate airflow to the passenger cabin, to regulate passenger cabin/outside air intake and various blend doors to regulate a mix of air from the AC evaporator 120, 120′, 220 and heater core 140, 140′, 240. It will be understood that there are many ways in which air can be effectively directed and the present invention is not intended to be limited to any specific method, apparatus for directing air.

The recent trend in engine design is toward more powerful engines desired by consumers and better fuel economy driven by oil prices and federal Corporate Average Fuel Economy (“CAFE”) requirements. This means that increasingly engines are turbocharged and use many technologies such as EGR coolers, transmission oil coolers and the like to meet the power and fuel economy goals. Many of these fuel economy improvement technologies generate more heat under the hood and, therefore, require more air flow under the hood to adequately cool the engine. The under hood engineer typically desires to design the vehicle with as open of a front-end as possible to allow lots of airflow to come into the underhood to help meet the engine cooling requirements. The external body designer of the vehicle, on the other hand, typically desires for the vehicle design to be a sleek, aerodynamic shape with very little front-end opening to reduce the drag of the vehicle and make it look visually appealing to potential buyers. Reducing the drag also improves the fuel economy significantly. One of the most significant impacts of the present invention is that less airflow is needed from the front end of the vehicle, which will, in turn, reduce the drag of the vehicle and the fuel consumed by the vehicle. For example, at highway speeds, about 60% of the power required to cruise is used to overcome aerodynamic effects. By minimizing this drag, by reducing airflow requirements underhood, embodiments of the present invention translated directly into improved fuel economy.

For example, a typical front end radiator needs to remove about 50 kW from a typical passenger carengine when running in normal city driving. The heat that needs to be removed jumps up to about 60 kW when the engine is working hard and towing a trailer. The front end radiator and grill opening are designed for the higher strain scenario. A typical heater core can remove about 10 kW of heat. This means that if the heater core is employed to remove heat to its full potential, then the radiator can be deigned to remove 50 kW (enough heat under most circumstances) and the heater core can remove the remaining 10 kW of heat from the engine. The airflow required through the front-end radiator to remove 50 kW of heat rather than 60 kW of heat is almost linearly related to the amount of heat that needs removing. Therefore, about 20% less airflow through the radiator is required in this example, which will lead to fuel economy gains presuming that the vehicle manufacturer designs the front end of the vehicle accordingly to take advantage of the lower airflow requirement.

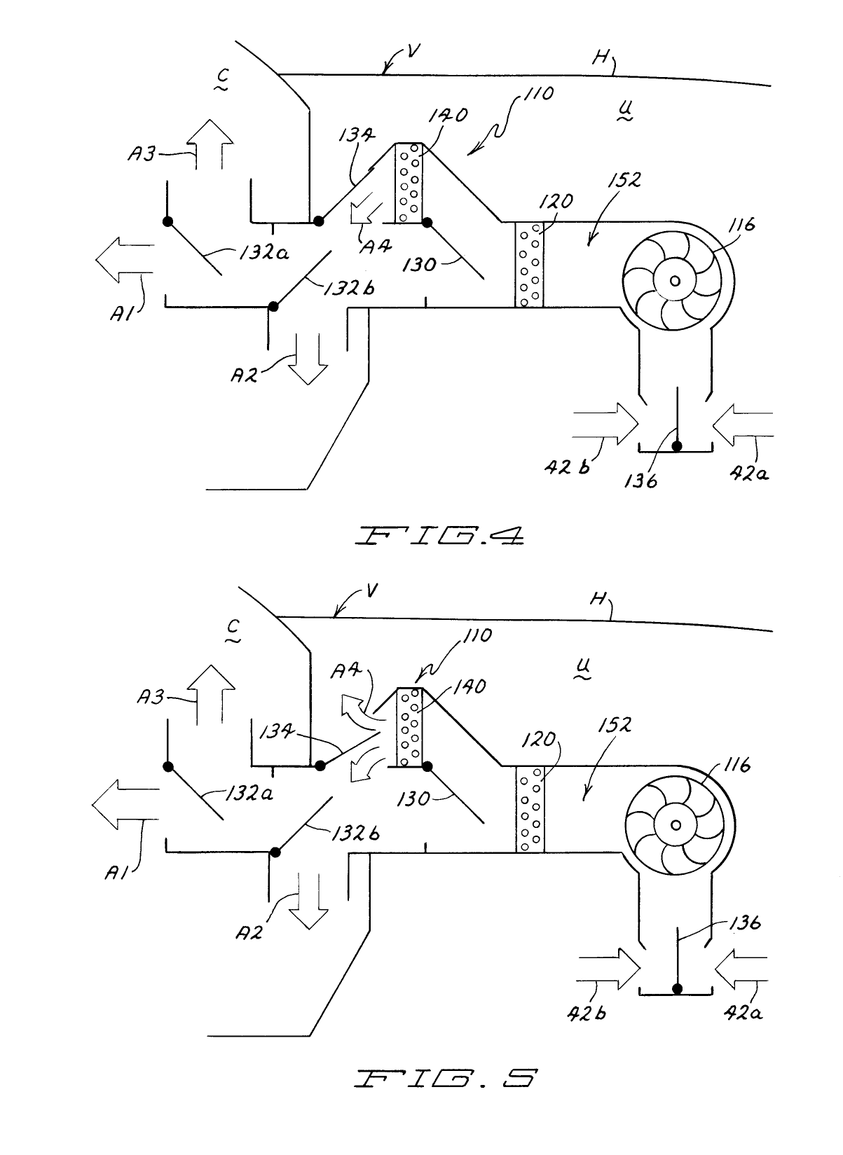

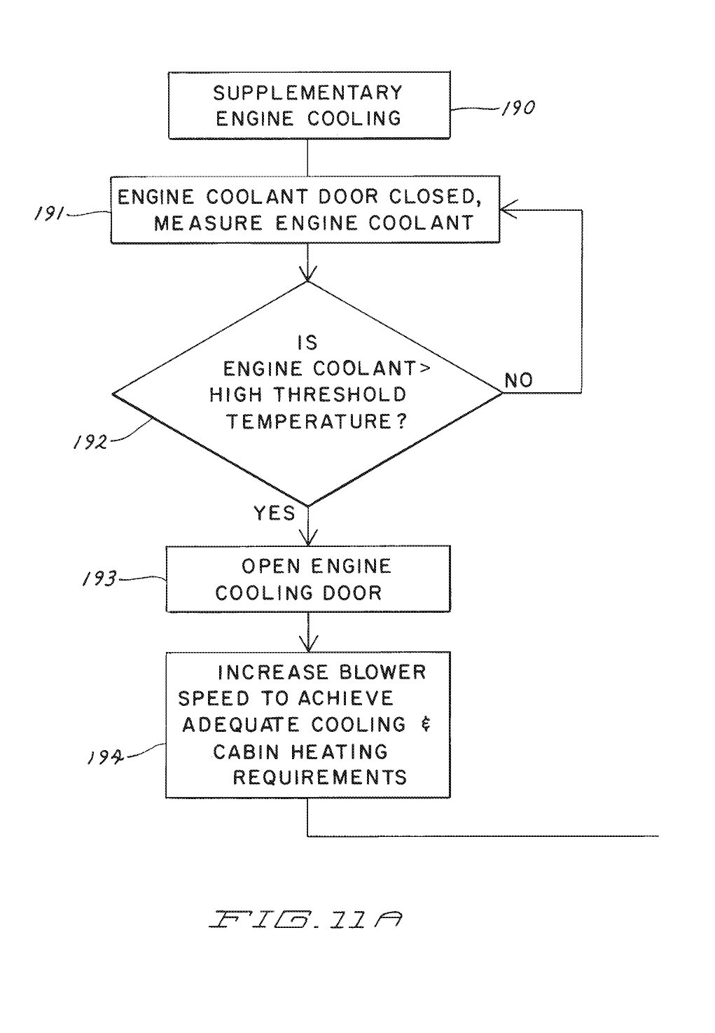

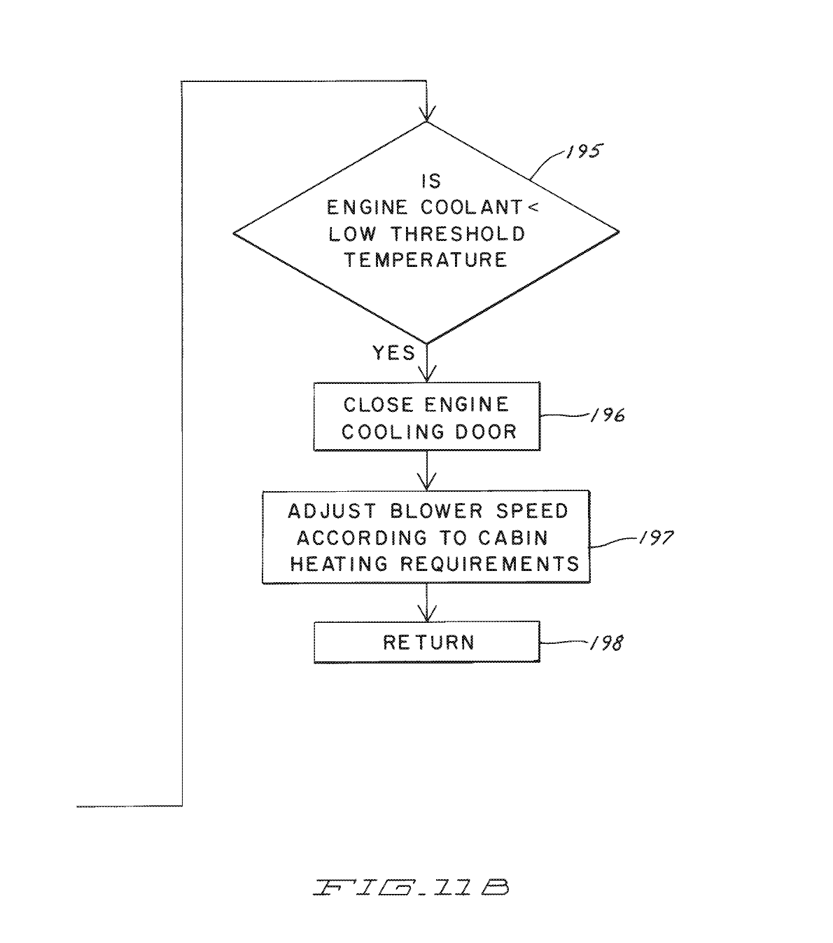

Preferred methods are disclosed herein and further illustrated in the flow charts of FIGS. 10-11 B. Turning now also to FIG. 10, it is preferably determined if supplemental engine cooling is required 180 by monitoring the desired parameter of the engine 124 such as coolant fluid 119 temperature or engine 124 oil temperature, for example. If supplemental engine cooling is required and the cabin heat is on 181, the cooling door 134, 134′, 234 will preferably be partially open 183 so that heated air A4 from the cooling system is vented to both the underhood area U and the passenger cabin C (see also, FIG. 5, for example). If supplemental engine cooling is required but the cabin heat is not on 181, the cooling door 134, 134′, 234 will be completely open 184 so that heat from the HVAC airbox system 110, 110′, 210 is vented only to the underhood area U (see also, FIG. 3, for example). If supplemental engine cooling is not required 180 and the cabin heat is on 182, the cooling door 134, 134′, 234 will be closed 185 so that heated air A4 from the cooling system 110, 110′, 210 is directed into the passenger cabin C. If supplemental engine cooling is not required 180 and the cabin heat is off 182, the cooling door 134, 134′, 234 and the blend door 230 are closed 186.

Turning also now to FIGS. 11A-11B, which illustrates a further preferred method of operating the HVAC airbox systems 110, 110′, 210 disclosed herein. As illustrated, initially the engine cooling door 134, 134′, 234 is closed and engine coolant temperature is measured 119. When supplementary engine cooling is required 190 (e.g. when the radiator 112 cannot sufficiently cool the engine 124), as determined by when the coolant 119 temperature is greater than the predetermined high threshold temperature 192, the cooling door 134, 134′, 234 is opened 193 and the blower 116, 116″, 216 speed is increased to achieve adequate engine cooling and cabin C heating and/or requirements 194. This mode of operation continues as long as supplemental cooling is required. The cooling door and the blower speed might be adjusted by the ECU to increase the supplemental cooling provided. When the coolant temperature becomes less than a predetermined lower threshold temperature, the engine cooling door 196 is closed and the blower 116, 116′, 216 speed is adjusted according to cabin C heating requirements 197. This cycle is repeated 198 as the coolant 119 temperature fluctuates. As will be appreciated, the methods disclosed in FIGS. 10-11B can be performed with any metric desired, such as a specific engine oil temperature, and are not limited only to evaluating coolant temperature.

In one example, if the coolant 119 temperature is greater than 220 degrees F., the engine cooling door 134, 134′, 234 is opened, and the cooling door 134, 134′, 234 is closed when the coolant temperature falls below 220 degrees F. Then the cooling door 134, 134′, 234 will reopen when the coolant 119 temperature reaches 221 degrees F. and will close as soon as temperature drops to 219 degrees F. This will make the door open and close every few seconds, which is less preferred as it will increase wear and tear on the cooling door 134, 134′, 234.

What is more preferred is that the cooling door 134, 134′, 234 should be closed when coolant 119 temperature drops below 210 degrees F. (i.e., the cooling door 134, 134′, 234 is open when coolant temperature goes above 220 degrees F. (higher threshold coolant temperature”, but the door only closes when coolant temperature drops to a lower threshold coolant temperature (e.g. 210 degrees F.). It is believed that this method will result in an engine cooling system that is more stable. In preferred embodiments, the difference between the high threshold temperature and the low threshold temperature is about 2 to about 15 degrees Fahrenheit and the exact temperature gap between low and high threshold can vary depending the size of the engine and the design of the vehicle.

Preferred methods of cooling a combustion engine 124 that is part of a vehicle V having a passenger cabin C and an underhood area in which the combustion engine 124, 124′ is located include the steps of providing a combustion engine 124, 124′ capable of generating heat; a radiator 112 fluidly connected to the engine 124, 124′, the radiator having a coolant 119. The coolant 119 capable of absorbing heat from the engine 124. The vehicle V further including a HVAC airbox system 110, 110′, 210 having a heater core 140, 140′, 240 fluidly connected to the engine 124, 124′ such that heat absorbed by the coolant 119 can be transferred to the heater core 140, 140′, 240. The HVAC airbox system 110, 110′, 210 further including at least one blower 116, 116″, 216 capable of directing air through the heater core 140, 140′, 240. The HVAC airbox system 110, 110′, 210 further comprises an AC evaporator 120, 220, wherein air is directed from the blower 116, 216, through the AC evaporator 120, 220 and then to the heater core 140, 240. The method further includes the step of actuating a cooling door 134, 134′, 234 such that at least some of the air from exiting the heater core A4 is directed to the underhood area U of the vehicle V. In various methods, at least some of the air A4 exiting the heater core 140, 140′, 240 is directed to the passenger cabin C. In further preferred methods, the cooling door 134, 134′, 234 is adjustable such that the cooling door 134, 134′, 234 can direct the air exiting to the heater core 140, 140′, 240 to only the underhood area U, only the passenger cabin C or both the underhood area U and the passenger cabin C. In alternate preferred methods, substantially all of the air A4 exiting the heater core 140, 140′, 240 is directed to the underhood area U of the vehicle V. In further preferred methods, the engine cooling system 210 further includes a duct 260 proximate the heater core 240 such that the air A4 passing through the heater core 240 can be directed to the underhood area U and then to the bottom of the vehicle V via the duct 260.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A HVAC airbox system, which is part of a vehicle having an engine capable of generating heat, a radiator having a coolant, the coolant capable of absorbing heat from the engine, the vehicle further having a passenger cabin and an underhood area in which the HVAC airbox system is located, the HVAC airbox system comprising:
an AC evaporator;
a heater core fluidly connected to the engine such that heat absorbed by the coolant can be transferred to the heater core;
at least one blower capable of directing air through the heater core; and
a cooling door; wherein the cooling door can selectively be positioned such that at least some of the air moving through the heater core is directed to the underhood area of the vehicle.

2. The HVAC airbox system of claim 1, wherein the cooling door has at least three positions, wherein, in the first position, air exiting the heater core is directed to the passenger cabin; in the second position, air exiting the heater core is directed to the underhood area; and, in the third position, air exiting the heater core is directed to both the passenger cabin and the underhood area.

3. The HVAC airbox system of claim 2, wherein the system includes at least two blowers, wherein one blower directs air to the heater core and the second blower directs air to the AC evaporator.

4. The HVAC airbox system of claim 1, wherein substantially all of the air exiting the heater core is directed to the underhood.

5. The HVAC airbox system of claim 1, wherein the cooling door can pivot.

6. The HVAC airbox system of claim 1, further comprising a duct proximate the heater core such that the air passing through the heater core can be directed to the underhood area and to the bottom of the vehicle via the duct.

7. A HVAC airbox system, which is part of a vehicle having an engine capable of generating heat, a radiator having a coolant, the coolant capable of absorbing heat from the engine, the vehicle further having a passenger cabin and an underhood area in which the HVAC airbox system is located, the HVAC airbox system comprising: a heater core fluidly connected to the engine such that heat absorbed by the coolant can be transferred to the heater core;
an AC evaporator;
at least one blower capable of directing air through the heater core; and
a cooling door proximate the heater core; wherein the cooling door has at least three positions, wherein, in the first position, air exiting the heater core is directed to the passenger cabin; in the second position, air exiting the heater core is directed to the underhood area; and, in the third position, air exiting the heater core is directed to both the passenger cabin and the underhood area.

8. The HVAC airbox of claim 7, wherein the system includes at least two blowers, wherein one blower directs air to the heater core and the second blower directs air to the AC evaporator

9. The HVAC airbox of claim 7, wherein substantially all of the air exiting the heater core is directed to the underhood.

10. The HVAC airbox of claim 7, wherein the cooling door can pivot.

11. A method of cooling an engine that is part of a vehicle having a passenger cabin and an underhood area in which the engine is located; the method comprising the steps of:
providing an engine capable of generating heat; a radiator having a coolant, the coolant capable of absorbing heat from the engine; an AC evaporator; a heater core fluidly connected to the engine such that heat absorbed by the coolant can be transferred to the heater core; at least one blower capable of directing air through the heater core; and
actuating a cooling door such that at least some of the air from exiting the heater core is directed to the underhood area of the vehicle.

12. The method of claim 11, wherein at least some of the air exiting the heater core is directed to the passenger cabin.

13. The method of claim 11, wherein the cooling door is adjustable such that the cooling door can direct the air exiting to the heater core to only the underhood area, only the passenger cabin or both the underhood area and the passenger cabin.

14. The method of claim 11, wherein substantially all of the air exiting the heater core is directed to the underhood area of the vehicle.

15. The method of claim 11, wherein air is directed from the blower, through the AC evaporator and then to the heater core.

16. The method of claim 11, wherein the HVAC airbox system further includes a duct proximate the heater core such that the air passing through the heater core can be directed to the underhood area and then to the bottom of the vehicle via the duct.

17. The method of claim 11, wherein the HVAC airbox system is configured to have a high threshold temperature; wherein the cooling door opens such that air is directed to the underhood area when the coolant temperature reaches the high threshold temperature.

18. The method of claim 17, wherein the HVAC airbox system is configured to have a low threshold temperature; wherein the cooling door closes such that air is not directed to the underhood area when the coolant temperature reaches the low threshold temperature.

19. The method of claim 18, wherein the difference between the high threshold temperature and the low threshold temperature is about 2 to about 15 degrees Fahrenheit.

20. The method of claim 18, further comprising the step of providing supplemental engine cooling on demand using the heater core regardless of the passenger cabin heating and cooling requirements.
